(19) United States
(12) Patent Application Publication
(10) Pub. No.: US 2016/0189211 A1
(43) Pub. Date: Jun. 30, 2016

(54) PROVIDING ADVERTISEMENTS BASED UPON RECURRING EVENTS

(71) Applicant: Yahoo!, Inc., Sunnyvale, CA (US)

(72) Inventors: Varun Bhagwan, San Jose, CA (US); Jaikit Savla, Santa Clara, CA (US); Doug Sharp, San Francisco, CA (US); Rahul Teotia, Sunnyvale, CA (US); Jesper Andersen, Oakland, CA (US); Deepak Agarwal, Milpitas, CA (US); Jac Wang, San Jose, CA (US)

(21) Appl. No.: 14/586,879

(22) Filed: Dec. 30, 2014

(51) Int. Cl. G06Q 30/02

(52) U.S. Cl. CPC G06Q 30/0255

(57) ABSTRACT

Users may discuss recurring events (e.g., events occurring seasonally, periodically, annually, etc.) through content (e.g., an email message, social network data, natural language conversation, etc.). The user may need to purchase a product and/or a service based upon a recurring event (e.g., a birthday gift), but may have difficulty determining what to purchase and/or may have forgotten about the recurring event. As provided herein, once identified, the recurring event may be added to a calendar of the user. An event type (e.g., a birthday event type, a seasonal event type, an annual event type, a periodic event type; etc.) of the recurring event may be identified. Supplemental content (e.g., an advertisement, a product recommendation, and/or a service recommendation), identified based upon the event type, past purchases related to the recurring event, a relationship of the user to the recurring event, etc., may be provided to the user.

### BACKGROUND

Users may discuss events, some of which are recurring events (e.g., events occurring seasonally, periodically, annually, etc.) through content (e.g., an email message, social network data, a natural language conversation, etc.). The user may need to purchase a product and/or a service based upon the recurring event, but may have difficulty determining what to purchase (e.g., the recurring event may be a yearly camping trip and the user may not know where to purchase a new tent, a poncho, etc.) and/or may have forgotten about the trip. In an example, if the content comprises an evite (e.g., an email comprising an invitation) corresponding to a recurring birthday event, then multiple users may purchase a same product and/or service as a gift for the birthday user, thus resulting in duplicated gifts.

### SUMMARY

In accordance with the present disclosure, one or more systems and/or methods for providing relevant advertisements based upon detecting a recurring event are provided. In an example, content associated with a user may be evaluated to identify the recurring event. The content may comprise an email message, social network data, and/or a natural language conversation. The recurring event may be identified by identifying a recurring indicator term within the content (e.g., our “annual” party, “birthday”, “it is that time of the year again”, a “weekly” study group, etc.).

The evaluating may comprise determining that the recurring event is of sufficient interest to the user, by determining that the recurring event exceeds an event threshold (e.g., the content or other user data such as previous social network posts may indicate that the user attended a weekly study group last week). The evaluating may comprise determining a frequency (e.g., once a year, twice a month, etc.) of the recurring event. A repository of recurring events may be created from the content based upon the frequency.

The recurring event may be added to a calendar. Responsive to the recurring event being added to the calendar, an option to remove the recurring event from the calendar and/or an option to receive a reminder about the recurring event may be offered. A future recurring event may be predicted from the content. An event type of the recurring event may be identified (e.g., a seasonal event type, an annual event type, and/or a periodic event type).

Supplemental content (e.g., an advertisement, a product recommendation, and/or a service recommendation), associated with the event type, may be obtained by communicating with a supplemental content provider. The supplemental content may be provided to the user through an email, a social network post, and/or a mobile alert. A social graph may be built by identifying an associated user associated with the recurring event and coordinating the supplemental content between the user and the associated user (e.g., the supplemental content may be provided to both the user and the associated user based upon the social graph indicating a similarity between the user and the associated user above a similarity threshold, such that a node, representing the user, may be connected within the social graph to a second node representing the associated user).

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of providing relevant advertisements based upon detecting a recurring event.

FIG. 5 is a component block diagram illustrating an example system for providing relevant advertisements based upon detecting a recurring event.

FIG. 6A is a component block diagram illustrating an example system for providing relevant advertisements based upon detecting a recurring event, where the recurring event comprises a birthday.

FIG. 6B is a component block diagram illustrating an example system for providing relevant advertisements based upon detecting a recurring event, where a social graph is built.

FIG. 7 is a component block diagram illustrating an example system for providing relevant advertisements based upon detecting a recurring event, where the recurring event comprises a seasonal event.

FIG. 8 is a component block diagram illustrating an example system for providing relevant advertisements based upon detecting a recurring event, where the recurring event comprises a periodic event.

FIG. 9 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

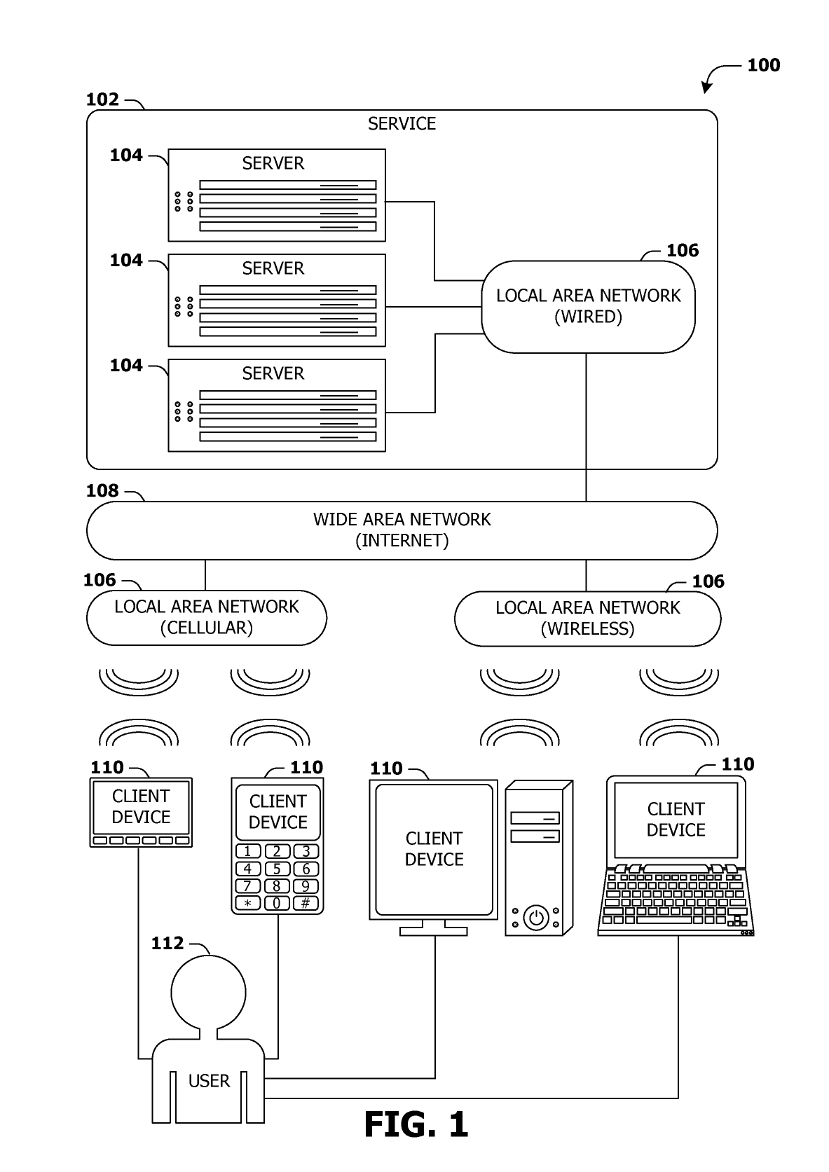

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

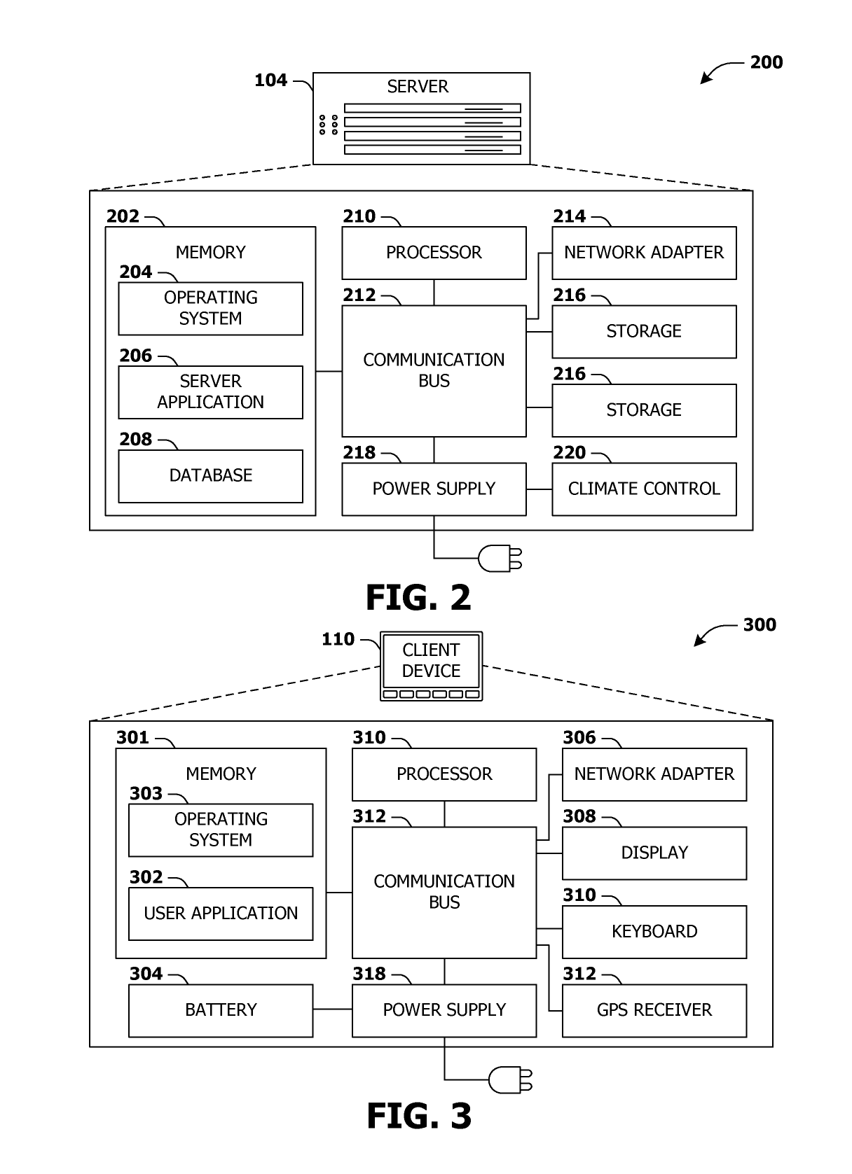

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

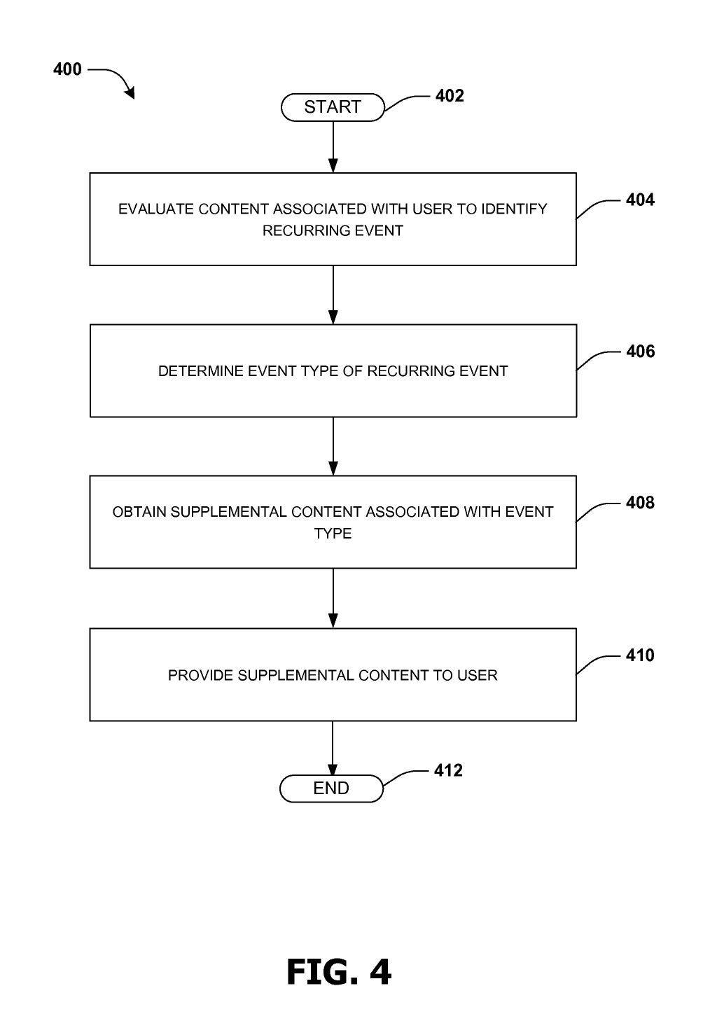

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques of providing relevant advertisements based upon detecting a recurring event are provided. Users may discuss a recurring event (e.g., an event that occurs seasonally, periodically, annually, etc.) through content (e.g., an email message, social network data, natural language conversation, person to person communication, etc.). Unfortunately, the user may forget to purchase a product and/or service for the occurrence of the recurring event and/or the user may have a difficult time determine what to purchase. In an example, if the content comprises person to person communication, such as a text message, about a recurring seasonal trip such as a winter skiing trip, then the user may desire to reserve tickets for a gondola ride, but may have difficulty finding a nearby gondola ride provider.

Accordingly, as provided herein, when the recurring event exceeds an event threshold (e.g., the recurring event exceeding the event threshold may indicate that the user has a sufficient level of interest in the recurring event, whereas the recurring event not exceeding the event threshold may indicate that the recurring event is not interesting to the user such as a recurring political fundraiser invite that the user routinely declines), the recurring event may be added to a calendar, and a reminder of the recurring event may be set (e.g., so that the user does not forget the recurring event). An event type of the recurring event may be identified (e.g., a birthday event type, a seasonal event type, an annual event type, and/or a periodic event type). Supplemental content (e.g., an advertisement, a product recommendation, and/or a service recommendation) associated with the event type may be obtained by communicating with a supplemental content provider (e.g., a business that offers the product and/or service). A social graph may be built by identifying an associated user associated with the recurring event and coordinating the supplemental content between the user and the associated user.

The ability to provide users with supplemental content associated with recurring events may reduce network bandwidth, time, and/or computing resources otherwise utilized by users in an attempt to locate such supplemental content on their own (e.g., manually searching websites for services and/or products). For example, if the recurring event is the user's father's birthday, prior purchases for the father's birthday and/or the social graph (e.g., comprising associated user's previous purchases and/or supplemental content associated with birthday parties of fathers) may be utilized to identify an advertisement for a product and/or service that may be interesting and/or relevant to the user's father. Many content providers may not have information, processing resources, and/or network bandwidth to leverage recurring events to obtain supplemental content relevant to the recurring event and/or provide the supplemental content to the user.

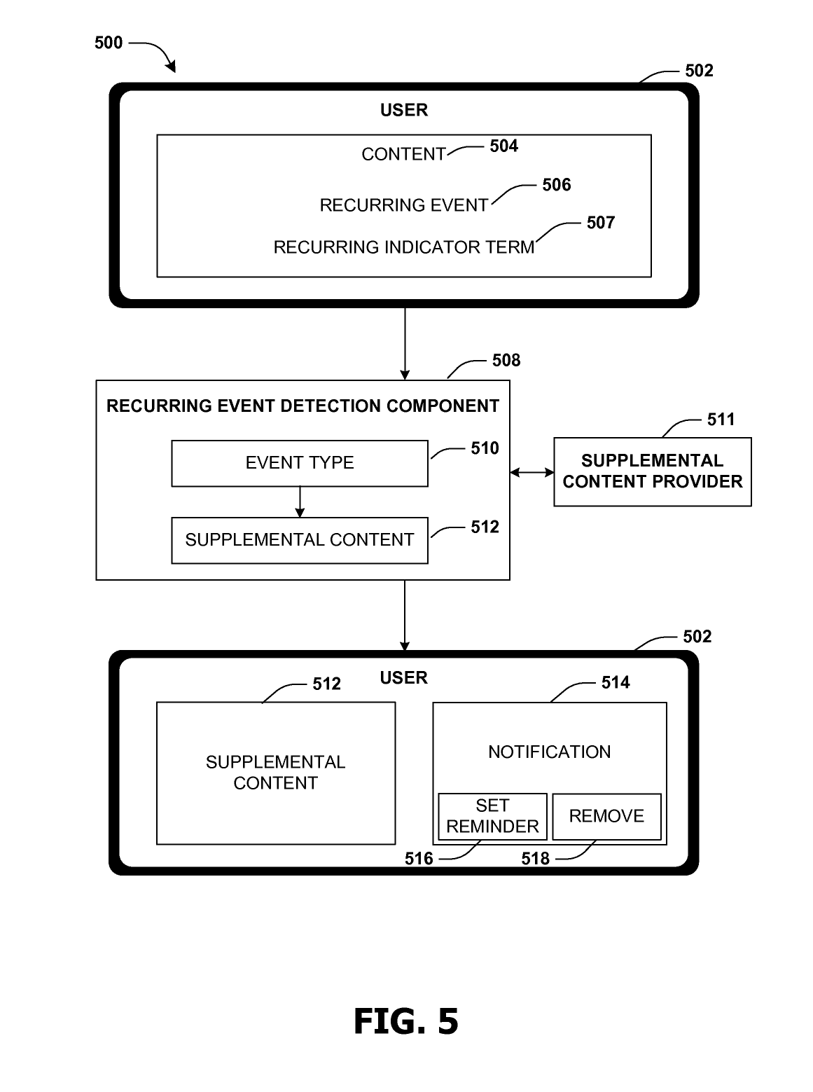

An embodiment of a method of providing relevant advertisements based upon detecting a recurring event is illustrated by an example method 400 of FIG. 4. At 402, the method starts. A user, of a client device, may generate content (e.g., an email message, social network data, a natural language conversation, person to person communication, etc.). The content may describe the recurring event (e.g., an event that occurs seasonally, periodically, annually, etc.). At 404, the content may be evaluated to identify the recurring event. The recurring event may be identified by identifying a recurring indicator term (e.g., annually, yearly, birthday, some increment of time, etc.) within the content, such as within a character proximity of an event description term (e.g., birthday, trip, meeting, appointment, etc.).

The user may take affirmative action, such as providing opt-in consent, to allow access to and/or use of the content (e.g., social network posts, microblogs, videogame console usage, etc.), such as for the purpose of providing relevant supplemental content based upon detected recurring events within content associated with the user (e.g., where the user responds to a prompt regarding the collection and/or use of such information).

At 406, an event type of the recurring event may be determined. The event type may be based upon a frequency of the recurring event (e.g., a seasonal event type, such as summer, fall, winter, and/or spring; a periodic event type, such as once every three months; etc.). In an example, an option to add the recurring event to a calendar may be presented to the user. Responsive to selection of the option, the recurring event may be added to the calendar. In an example, the user may be offered an option to remove the recurring event from the calendar (e.g., where the recurring event was automatically added to the calendar) and/or an option to receive a reminder about the recurring event. Responsive to the recurring event occurring on an unknown future date (e.g., the recurring event occurring on some date in winter, on a date approximately 6 months from a current date, etc.), the recurring event may be added to the calendar for only the current year or a date range.

The recurring event may be added to a repository of recurring events. The recurring event may be linked to the user (e.g., recurring event entries, within the repository, may be indexed by users associated with such recurring events). The repository may comprise an event database populated with one or more tables correlating recurring events with content relevant to such recurring events such as purchases related to the recurring event. In an example, a first recurring event entry may correlate a yearly Fourth of July party with a firework purchase, a second recurring event entry may correlate a monthly shopping trip with a shoe purchase, etc.

At 408, supplemental content (e.g., an advertisement, a service recommendation, and/or a product recommendation) associated with the event type may be obtained. The supplemental content may be obtained by communicating with a supplemental content provider (e.g., a website comprising a description of a product, an advertiser providing an advertisement of the product, an application through which the service may be provided, etc.). A social graph may be built by identifying an associated user that is associated with the recurring event. The social graph may comprise nodes, representing users, that are connected by edges representing associations between users related to the recurring event. The social graph may be evaluated to identify one or more users that are related to the recurring event so that the supplemental content may be coordinated between such users. In an example, if the content comprises an email inviting the user and a second user (e.g., the associated user) to an anniversary reunion event, then the supplemental content may be provided to the user and/or the second user (e.g., the supplemental content may be the same for both users such as taxi rides home from the anniversary reunion event or may be different such as a wine suggestion for the user that responded with a “I am bringing wine” message and an appetizer suggestion for the second user that responded with a “I am bringing an appetizer” message).

At 410, the supplemental content may be provided to the user (e.g., through an email, a social network post, and/or a mobile alert). The supplemental content (e.g., an advertisement for a taxi ride) may be provided to the user and/or the second user. The supplemental content may comprise a supplemental content notification. The supplemental content notification may recommend a product and/or a service, a purchased product and/or purchased service that was purchased by the second user, an option to split the purchase of the product and/or the service with another, etc. In an example, prior to a future occurrence of the recurring event, the repository may be evaluated to identify a supplemental content recommendation to provide to the user (e.g., a next occurrence of a birthday party may be identified, and a videogame gift suggestion may be provided to the user a month before the next occurrence of the birthday party). The supplemental content recommendation may be provided to the user prior to a date on which the recurring event occurs. At 412, the method ends.

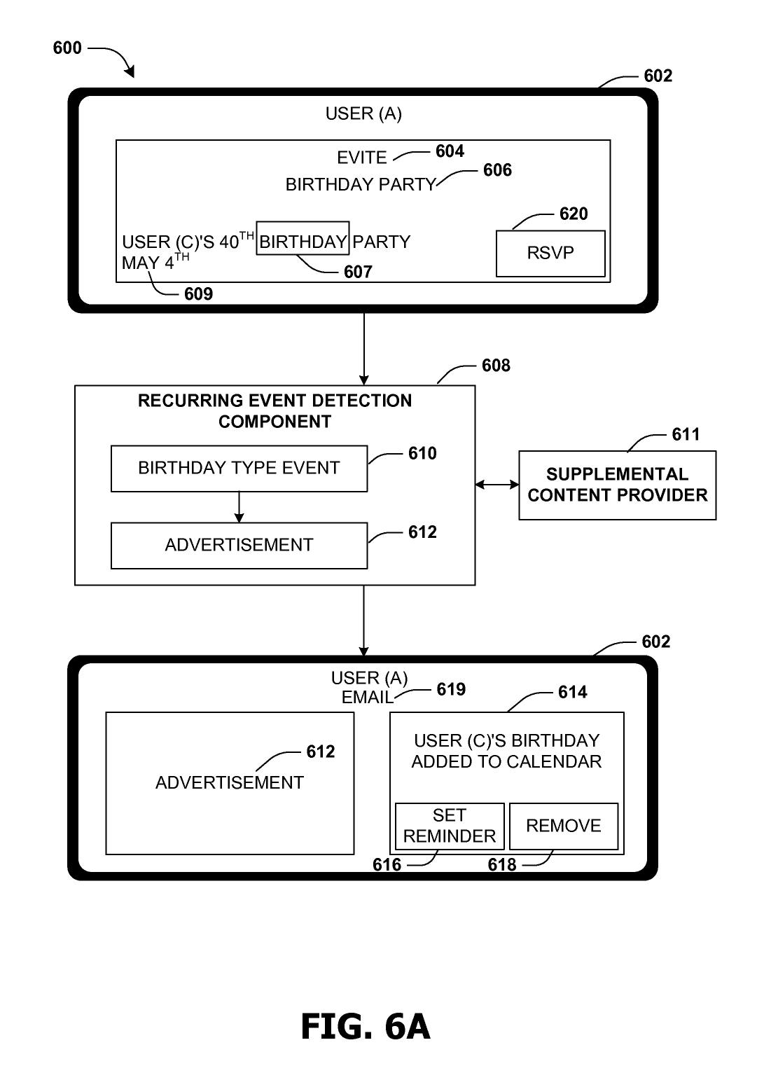

FIG. 5 illustrates an example of a system 500, comprising a recurring event detection component 508, for identification of a recurring event 506. A user, of a client device 502, may generate content 504 comprising an indication of the recurring event 506. The recurring event detection component 508 may evaluate the content 504 to identify the recurring event 506. The recurring event 506 may be identified by identifying a recurring indicator term 507 within the content 504, such as the terms “yearly party” and “last year” within an email message “Hey, are you coming to the yearly party for work . . . it was so much fun last year.”

The recurring event detection component 508 may determine whether the recurring event 506 exceeds an event threshold. The event threshold may specify a threshold interest level of the user (e.g., prior event attendance data, social network posts, a user profile, prior purchases, expressed interests of the user, and/or other user information may be used to score the recurring event 506). In an example, the user's interest level in the recurring event 506 may not exceed the event threshold based upon the recurring event 506 being peripheral to the user (e.g., a friend's father's birthday may be mentioned in the content 504, but the user may not know the friends father). In an example, the user's interest level in the recurring event 506 may exceed the event threshold based upon the recurring event 506 being central to the user (e.g., the user's parent's anniversary, the user's spouse's birthday, etc.). The user's level of interest may be determined by a relationship between the user and the recurring event 506 (e.g., a doctor appointment event may be more relevant to the user if the doctor appointment event is for the user as opposed to a friend of the user). The user's level of interest may be determined by a number of times that the recurring event 506 is mentioned in various content associated with the user (e.g., if a birthday party is mentioned in two emails and a social media post, then it is likely that the user will have an interest in the birthday party over the event threshold). Responsive to the recurring event 506 not exceeding the event threshold, the recurring event 506 may be deemed unidentified (e.g., no further action may be taken with regard to the recurring event 506).

The recurring event detection component 508 may determine an event type 510 of the recurring event 506. The recurring event detection component 508 may add the recurring event 506 to a calendar of the user. The recurring event detection component 508 may present a notification 514 that the recurring event 506 has been added to the calendar. The recurring event detection component 508 may present the user with an option to remove 518 the recurring event 506 from the calendar and/or an option to receive a reminder 516 about the recurring event 506.

The recurring event detection component 508 may add the recurring event 506 to a repository of recurring events. The recurring event 506 may be linked to the user (e.g., identifying information of the client device 502 may be linked to the recurrent event 506). The repository may comprise an event database comprising year(s), date(s), and/or time(s) of recurring events, purchased services, and/or purchased products related to the recurring events, etc. The recurring event detection component 508 may obtain supplemental content 512 associated with the event type 510. The supplemental content 512 may be obtained by communicating with a supplemental content provider 511 (e.g., an advertiser, an app store, a website, etc.).

The supplemental content provider 511 may make a bid against a second supplemental content provider that provides a second supplemental content (e.g., a second business providing an advertisement, an offer for a service and/or a product, which may be similar to the supplemental content 512 provided by the supplement content provider 511). In an example, if the recurring event 506 is a doctor's appointment, then the supplemental content provider 511 may comprise a first pharmacy store and the second content provider may comprise a second pharmacy store. The supplemental content 512 and/or the second supplemental content may comprise an advertisement for medical products. In an example, if the supplemental content provider 511 offers the higher bid, relative to the second supplemental content provider, then the recurring event detection component 508 may provide the supplemental content 512 to the user (e.g., through an email, a social network post, and/or a mobile alert). In an example, if the second supplemental content provider offers the higher bid, relative to the supplemental content provider 511, then the recurring event detection component 508 may provide the second supplemental content to the user.

The recurring event detection component 508 may track whether the user selects the supplemental content 512 and/or makes a purchase based upon the supplemental content 512. The recurring event detection component 508 may utilize a pay structure, wherein the supplemental content provider 511 may pay a fee when the supplemental content 512 is selected by the user and/or when the user purchases a product and/or service provided by the supplemental content 512

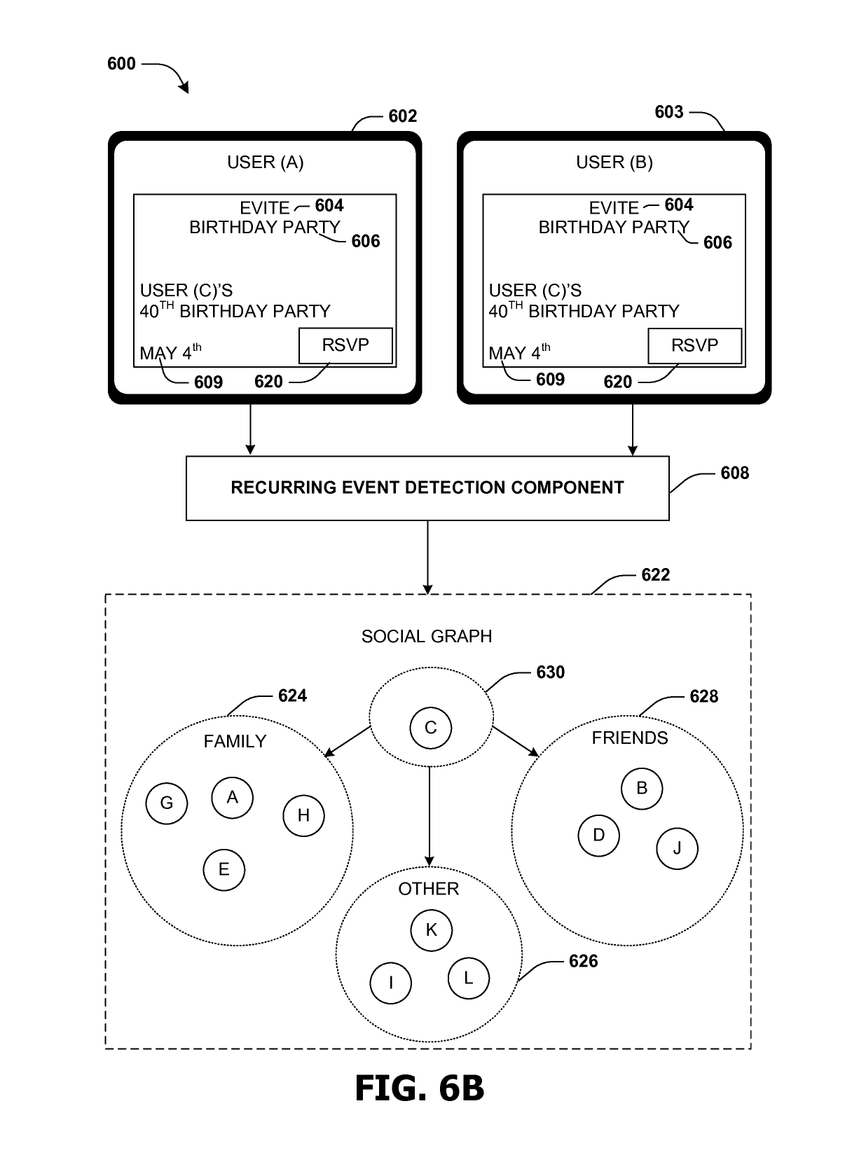

FIGS. 6A-6B illustrate an example of a system 600 comprising a recurring event detection component 608 that identifies a birthday party 606 (e.g., a recurring event) and generates a social graph 622 associated with the birthday party 606. A user (A), of a client device 602, may receive an evite 604 (e.g., an invitation sent via email to invite users to an event) for the birthday party 606 of a user (C) occurring on a date 609 (e.g., May 4^{th}). The recurring event detection component 608 may evaluate the evite 604 to identify the birthday party 606 as the recurring event. The birthday party 606 may be identified by identifying “birthday” 607 as a recurring indicator term. The evite 604 may comprise an option to RSVP 620 (e.g., an option to indicate that the user (A) will or will not attend the birthday party 606). The recurring event detection component 608 may identify a list of users that have received the evite 604 and/or RSVPed to the birthday party 606.

The recurring event detection component 608 may determine that the birthday party 606 comprises a birthday type event 610. The recurring event detection component 608 may add the birthday party 606 to a calendar of the user. The recurring event detection component 608 may access social media, a user profile, and/or a user history of the user (C) to determine that the May 4^{th} date of the birthday party 606 is user (C)'s actual birth date, and thus a user (C)'s birthday calendar entry may be added to the calendar.

The recurring event detection component 608 may present a notification that the user (C)'s birthday is added to the calendar 614. The recurring event detection component 608 may present the user an option to remove 618 the birthday party 606 from the calendar and/or an option to receive a reminder 616 about user (C)'s birthday party 606.

The recurring event detection component 608 may add the birthday party 606 to a repository of recurring events. The birthday party 606 may be linked to the user (A) (e.g., the client device 602 may comprise an identification component, an IP address, etc. to identify user (A)). The recurring event detection component 608 may obtain an advertisement 612 associated with the birthday type event 610. The advertisement 612 may be obtained by communicating with a supplemental content provider 611.

The recurring event detection component 608 may access social media, the user profile, and/or the user history of the user (C) to obtain an advertisement 612 for a product and/or service that may be interesting and/or relevant to user (C). The recurring event detection component 608 may obtain the advertisement 612 for the product and/or service based upon prior products and/or services that the user (A) may have purchased for the user (C). In an example, the repository may comprise a previous entry for the birthday party 606 and preemptively obtain the advertisement 612 based upon a previous entry such as before the user (A) receives the evite 604. In an example, if the user (A) purchased a fishing rod for the user (C) in a prior year for the user (C)'s birthday, then the advertisement 612 may comprise an offer for fishing related products (e.g., bait, tackle, etc.). In an example, responsive to the user profile of the user (C) indicating that the user (C) enjoys hunting, the advertisement 612 may comprise an offer for a hunting trip. The recurring event detection component 608 may provide the advertisement 612 to the user through an email 619.

FIG. 6B illustrates an example of the recurring event detection component 608 generating the social graph 622 associated with the birthday party 610. The user (A) of the client device 602 and a user (B) of a second client device 603, may RSVP 620 to the user (C)'s birthday party 606. The recurring event detection component 608 may generate the social graph 622 comprising users that have RSVPed 620 to the birthday party 606. The recurring event detection component 608 may group users based upon a relationship (e.g., family, friends, etc.) of the users to a subject 630 of the birthday party 606 (e.g., the user (C) for which the birthday party 606 is being thrown). The relationship to the user (C) may be determined, with the user (C)'s consent, by utilizing the user (C)'s social media activity (e.g., by analyzing users that are linked to the user (C) through social media, users that post to the user(C)'s social media, etc.), natural language conversations (e.g., users with whom the user (C) converses; users that are mentioned in emails, text messages, etc.; etc.), the user (C)'s profile (e.g., which may comprise relationship status, family, friends, etc.), etc.

For example, a family group 624 may comprise the user (A) (e.g., the user (C)'s wife), a user (E) (e.g., the user (C)'s sister), a user (G) (e.g., the user (C)'s brother), a user (H) (e.g., the user (C)'s daughter), and/or other users that are related to user (C) (e.g., a brother-in-law, mother, father, etc.). A friends group 628 may comprise a user (B) (e.g., a high school friend of the user (C)), a user (D) (e.g., a family friend of the user (C)), a user (J) (e.g., a childhood friend of the user (C)) and/or other users that are friends with the user (C). In an example, the relationship between user (C) and other users may be determined through social media connections, natural language found in the invite (e.g., if the evite is sent by the user (A), then the evite may state “please attend my husband's birthday” indicating user (A)'s relationship to user (C)). An other group 626 may comprise a user (I), a user (K), a user (L), and/or other users that may not be grouped as friends and/or family of the user (C). In an example, a user may be grouped into one or more groupings.

The advertisement 612 may be obtained based upon the social graph 622. In an example, an advertisement for a relatively higher priced item may be provided to users in the family group 624 compared to users in the other group 626 (e.g., because a family member may be more likely to spend a higher amount of money on a gift than a mere acquaintance). In an example, the user (D), a friend with which user (C) converses with often, may be more likely to spend a higher amount than the user (J), a friend that the user (C) rarely converses with. Thus the user (D) may be presented with an advertisement for a higher priced product and/or service than the user (J).

Based upon the social graph 622, a first advertisement may be offered to the user (A) and a second advertisement may be offered to the user (B). The first advertisement may be different than the second advertisement. Responsive to the user (A) purchasing a product (e.g., a hat) offered in the first advertisement, the second advertisement may comprise a second product that may compliment the first product (e.g., gloves that match the hat). The second advertisement may comprise a gift notification to the user (B) that the user (A) purchased the hat, and that the gloves match the hat.

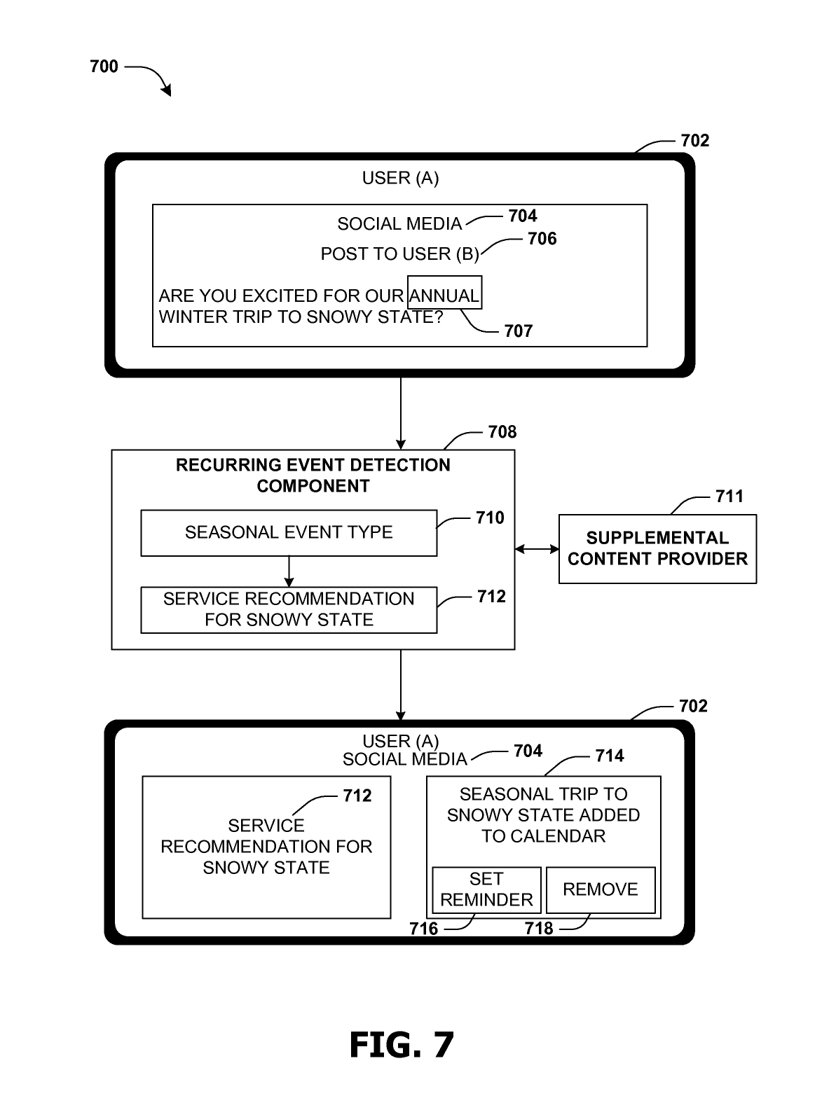

FIG. 7 illustrates an example of a system 700 comprising a recurring event detection component 708 that identifies a seasonal event type 710 (e.g., a recurring event). A user (A), of a client device 702, may generate a post 706 (e.g., a message) to user (B) on social media 704. The recurring event detection component 708 may evaluate the post 706 to identify “winter trip to Snowy State” as the recurring event. The winter trip to Snowy State may be identified by identifying “annual” 707 as a recurring indicator term (e.g., “annual” 707 may imply that the event may occur around a same time every year).

The recurring event detection component 708 may determine that the winter trip comprises the seasonal event type 710. The recurring event detection component 708 may add the winter trip to a calendar of a user associated with the winter trip (e.g., the user (A) and/or the user (B)). The recurring event detection component 708 may enter the winter trip for only the current year or a date range, because even though the winter trip is a recurring event, a date of a future winter trip may be unknown.

The recurring event detection component 708 may present a notification 714 to the user that the winter trip is added to the calendar. The recurring event detection component 708 may present the user with an option to remove 718 the winter trip from the calendar and/or an option to receive a reminder 716 about the winter trip.

The recurring event detection component 708 may add the winter trip to a repository of recurring events. The winter trip may be linked to the user. The recurring event detection component 708 may obtain a service recommendation 712 for Snowy State ski resort associated with the seasonal event type 710. The service recommendation 712 may be obtained by communicating with a supplemental content provider 711 (e.g., a vacation website).

The recurring event detection component 708 may access social media, the user profile, and/or the user history of the user to determine a product and/or service that the user may prefer. In an example, the repository may comprise a previous entry for the winter trip and preemptively obtain the recommendation for the service based upon a previous entry, such as before the user receives the post 706. In an example, the recurring event detection component 708 may access the repository and on or near the start of winter (e.g., December 22^{nd}) and provide the user with a service recommendation 712 for Snowy State.

In an example, if the user (A) purchased a ski pass for Snowy State Ski resort in a previous year, then the service recommendation 712, provided to the user (A) and/or the user (B), may comprise an offer for the ski pass for Snowy State Ski resort and/or a competitor (e.g., another ski resort in Snowy State). Responsive to the user (B) purchasing the service recommendation 712, a purchase notification and/or the service recommendation 712 may be sent to the user (A). The purchase notification may state that the user (B) purchased the service recommendation 712.

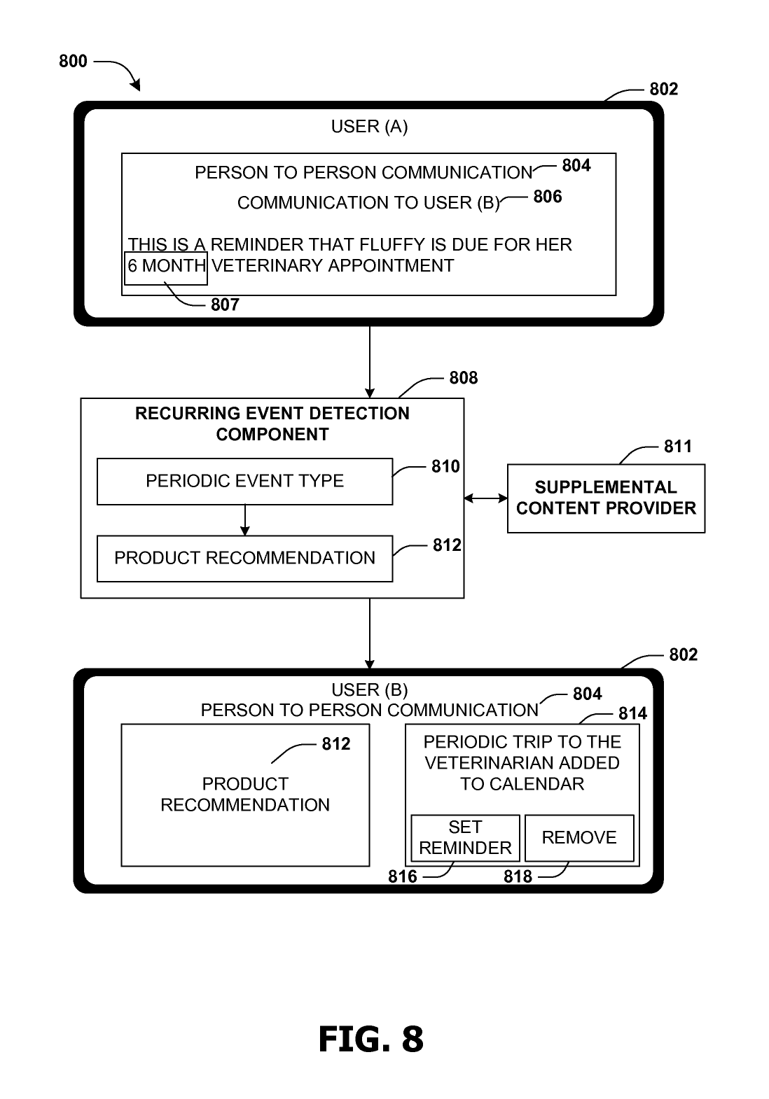

FIG. 8 illustrates an example of a system 800 comprising a recurring event detection component 808 that identifies a periodic event type 810 (e.g., a recurring event). A user (A) (e.g., a veterinarian) may generate a communication to a user (B) (e.g., a pet owner), such as through person to person communication 804 (e.g., text message, a text alert, etc.) of a client device 802. The recurring event detection component 808 may evaluate the person to person communication 804 to identify “veterinary appointment” as a recurring event. The veterinary appointment may be identified by identifying “6 month” 807 as a recurring indicator term (e.g., “6 month” 807 may imply that another veterinary appointment may be needed at a different point in time).

The recurring event detection component 808 may determine that the veterinary appointment comprises the periodic event type 810. The recurring event detection component 808 may add veterinary appointment to a calendar of the user (B). The recurring event detection component 808 may predict future recurring events of the veterinary appointment (e.g., based upon information, such as a general veterinary schedule, vaccination dates, physical dates, an age of Fluffy, etc.). The future recurring event may be added to a repository and/or the calendar. The repository may comprise an event database comprising year(s), date(s), and/or time(s) of the recurring events and/or one or more purchases made by user (B) related to the recurring event (e.g., pet medication).

The recurring event detection component 808 may present a notification 814 that the veterinary appointment is added to the calendar, responsive to the veterinary appointment being added to the calendar. The recurring event detection component 808 may present the user with an option to remove 818 the veterinary appointment from the calendar and/or an option to receive a reminder 816 about the veterinary appointment.

The recurring event detection component 808 may obtain a product recommendation 812 for Fluffy associated with the periodic event type 810 (e.g., a worm medicine in an amount sufficient to supply Fluffy for a 6 month period). The product recommendation 812 may be obtained by communicating with a supplemental content provider 811 (e.g., a pet medication store).

The recurring event detection component 808 may access social media, the user profile, and/or the user history of the user (B) to determine a product that the user (B) may prefer for Fluffy. In an example, the repository may comprise a previous entry for the veterinary appointment and preemptively give recommendations based upon the previous entry, such as before the person to person communication occurs 804. In an example, if the user (B) purchased a heart worm medication for Fluffy in a previous year, then the product recommendation 812 provided to the user (B) may comprise an offer for the same or a different heart worm medication.

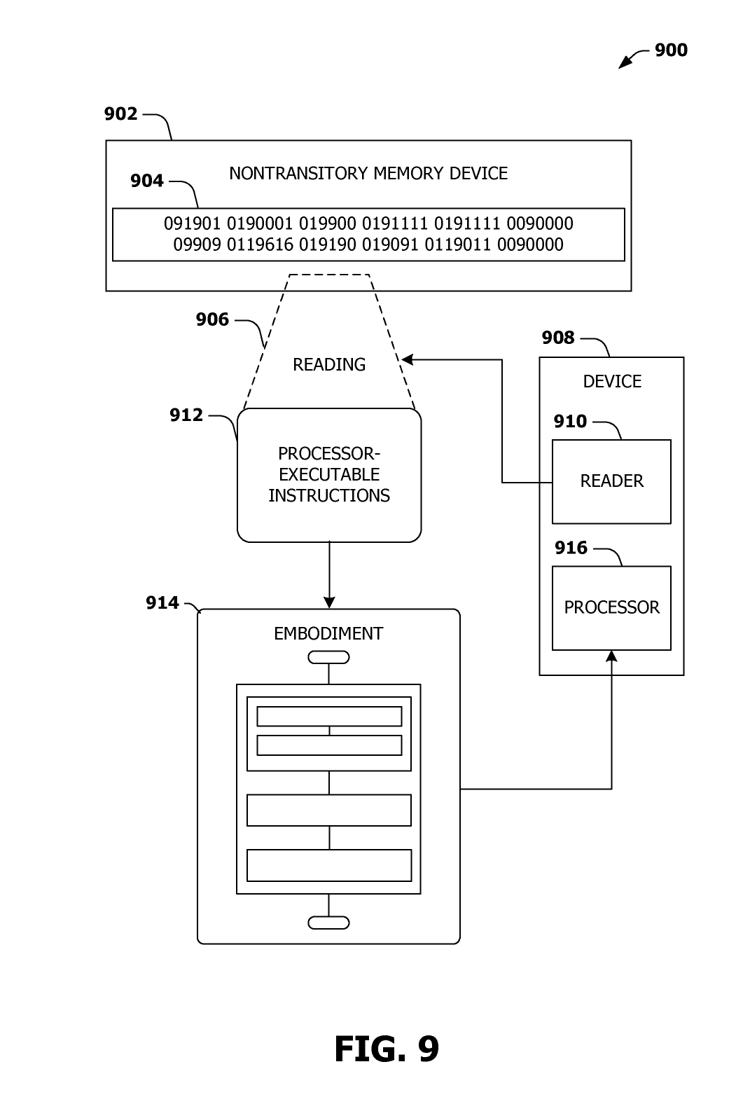

FIG. 9 is an illustration of a scenario 900 involving an example nontransitory memory device 902. The nontransitory memory device 902 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 902 stores computer-readable data 904 that, when subjected to reading 906 by a reader 910 of a device 908 (e.g., a read head of a hard disk drive, or a read operation invoked on a solid-state storage device), express processor-executable instructions 912. In some embodiments, the processor-executable instructions, when executed on a processor 916 of the device 908, are configured to perform a method, such as at least some of the example method 400 of FIG. 4, for example. In some embodiments, the processor-executable instructions, when executed on the processor 916 of the device 908, are configured to implement a system, such as at least some of the example system 500 of FIG. 5, at least some of the example system 600 of FIGS. 6A-6B, at least some of the example system 700 of FIG. 7, and/or at least some of the example system 800 of FIG. 8, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of providing relevant advertisements based upon detected recurring events, comprising:
evaluating content associated with a user to identify a recurring event;
determining an event type of the recurring event;
obtaining supplemental content associated with the event type; and
providing the supplemental content to the user.

2. The method of claim 1, comprising:
determining a frequency of the recurring event.

3. The method of claim 2, comprising:
creating a repository of recurring events from the content based upon the frequency.

4. The method of claim 1, comprising:
predicting a future recurring event from the content.

5. The method of claim 1, comprising:
adding the recurring event to a calendar.

6. The method of claim 5, comprising:
responsive to adding the recurring event to the calendar, offering an option to remove the recurring event from the calendar.

7. The method of claim 5, comprising:
responsive to adding the recurring event to the calendar, offering an option to receive a reminder about the recurring event.

8. The method of claim 1, the evaluating content comprising:
evaluating at least one of:
an email message;
social network data; or
a natural language conversation.

9. The method of claim 1, the evaluating content comprising:
identifying a recurring indicator term in the content.

10. The method of claim 1, the evaluating content comprising:
determining that the recurring event is of sufficient interest to the user by determining that the recurring event exceeds an event threshold.

11. The method of claim 1, the determining comprising:
identifying the event type as comprising at least one of:
a seasonal event;
an annual event; or
a periodic event.

12. The method of claim 1, the obtaining comprising:
communicating with a supplemental content provider to obtain the supplemental content.

13. The method of claim 1, the providing supplemental content comprising:
providing at least one of:
an advertisement;
a product recommendation; or
a service recommendation

14. The method of claim 1, the providing supplemental content comprising:
providing the supplemental content through at least one of:
an email;
a social network post; or
a mobile alert.

15. The method of claim 1, comprising:
building a social graph, the building a social graph comprising:
identifying an associated user associated with the recurring event; and
coordinating the supplemental content between the user and the associated user.

16. A system for providing relevant advertisements based upon detecting recurring events, comprising:
a recurring event detection component configured to:
evaluate content associated with a user to identify a recurring event;
determine an event type of the recurring event;
add the recurring event to a repository of recurring events;
obtain supplemental content associated with the event type; and
provide the supplemental content to the user.

17. The system of claim 16, the recurring event detection component configured to:
evaluate content comprising at least one of:
an email message;
social network data; or
a natural language conversation.

18. The system of claim 16, the recurring event detection component configured to:
determine the event type of the recurring event is at least one of:
a seasonal event;
an annual event; or
a periodic event.

19. The system of claim 16, the recurring event detection component configured to:
provide supplemental content comprising at least one of:
an advertisement;
a product recommendation; or
a service recommendation

20. A non-transitory computer readable medium comprising computer executable instructions that when executed by a processor perform a method for providing relevant advertisements based upon detected recurring events, comprising:
evaluating content associated with a user to identify a recurring event;
determining an event type of the recurring event;
adding the recurring event to a calendar;
obtaining supplemental content associated with the event type; and
providing the supplemental content to the user.
